(19) United States
(12) Patent Application Publication
(10) Pub. No.: US 2004/0128926 A1
(43) Pub. Date: Jul. 8, 2004

(54) Increased light transmissive glass block window system

(76) Inventor: Frank J. Tortorella JR., Park Ridge, IL (US)

Correspondence Address: McAndrews, Held & Malloy, Ltd., 34th Floor, 500 W. Madison Street, Chicago, IL, 60661, US

(21) Appl. No.: 10/667,719

(22) Filed: Sep. 22, 2003

Related U.S. Application Data
(63) Continuation-in-part of application No. 09/944,542, filed on Aug. 31, 2001, now abandoned.
(60) Provisional application No. 60/229,480, filed on Aug. 31, 2000.

(51) Int. Cl. E06B 3/00

(52) U.S. Cl. 52/204.5

(57) ABSTRACT

A glass block window system is provided with at least one substantially transparent glass block and at least one substantially transparent hopper vent bonded together using a substantially transparent adhesive. The hopper vent may include a window sash and a detachable screen. The window system is preferably prefabricated into a single unit for installation.

### BACKGROUND OF THE INVENTION

The present invention generally relates to a glass block window system. More particularly, the present invention relates to a glass block window system providing for increase light transmission by employing a substantially transparent or translucent window and substantially transparent or translucent adhesive.

Windows have been employed in the exterior walls of structures, such as dwellings for example, for hundreds of years. Windows may serve many uses, such as providing for ventilation, but one of the main advantages of windows is the admission of natural light into the interior of a structure. Light passing through a window may be useful for practical purposes, such as to provide illumination to the interior of the structure, or may additionally be useful to increase the aesthetic appeal of the window.

A typical window may be employed as part of a wall in a residential, commercial, or industrial structure. The window includes an exterior frame set into the wall, a transparent portion, such as glass, and an interior frame supporting the transparent portion within the exterior frame. The interior frame may be movable within the exterior frame to allow the window to be opened. Many alternatives to the typical window exists, for example, double hung windows which may include two interior frames, each including a transparent portion and each movable within the exterior frame.

In the present day, most window frames are fashioned by extrusion of metal, such as aluminum for example, wood, or a plastic material, such as vinyl or polyvinyl chloride (PVC) for example. Most recently, PVC has become an especially popular material for window frame construction because PVC is white, opaque, UV-stable, and easy to manufacture and process. Also, very recently, some manufacturers have begun to employ injection molding processes to manufacture window frames. However, these techniques also typically employ PVC or polypropelene because of its above-noted properties and its tradition of use in the industry. PVC may be either extruded or injection molded to form articles in any of a number of colors, but the formed articles, although colored, are opaque.

Although many embodiments of window frames may be employed, one important characteristic of most window frame systems is the amount of light that penetrates the window into the interior of the structure. Typically, windows allowing more light to penetrate into the interior of the structure provide brighter illumination and are often more desirable by consumers. Some techniques employed in the industry to increase total light penetration through a window include increasing the transparency of the window or shrinking the size of the window frame. However, both the transparency of the window and the size of the frame have practical limitations, such as structural stability, the necessity to attach to the surrounding wall, or the enclosure of opening or locking components which may provide a bottom limit for the size of the window frame. Additionally, many windows employ screens which may also serve to reduce the light transmitted through the window.

Specifically with regard to glass block window system, the typical glass block window system includes a plurality of glass blocks and at least one window or hopper vent. Typically, the window or hopper vent is centrally located and surrounded by glass blocks as installed.

Because the hopper vent is typically centrally located in the glass block window system and is typically constructed of an opaque material such as vinyl, aluminum or PVC, the hopper vent typically drastically reduces the light transmission through the window system.

Additionally, the window and the glass blocks are typically bonded to each other using an opaque adhesive such as mortar. The mortar between the glass blocks and between the glass blocks and the hopper vent may serve to reduce the amount of light transmitted through the window system. The amount of light transmitted may especially be reduced when the exterior light source is at an acute angle to the window system.

Thus, a need has long be felt for a glass block window system that provides increased light transmission. A need has especially been felt for such a glass block window system that minimizes the reduction in light transmission due to the hopper vent and bonding between the glass blocks and hopper vent.

### SUMMARY OF THE INVENTION

A preferred embodiment of the present invention provides a glass block window system providing for increased light transmission. The window system includes at least one substantially transparent glass block and at least one substantially transparent hopper vent bonded together using a substantially transparent adhesive. Increased light transmission is provided because the hopper vent and the adhesive are transparent.

These and other features of the present invention are discussed or apparent in the following detailed description of the embodiments of the invention.

### BRIEF DESCRIPTION OF THE DRAWINGS

FIG. 1 illustrates a perspective view of a non-opaque hopper vent according to a preferred embodiment of the present invention.

FIG. 2 illustrates several embodiments of non-opaque window framing systems for windows and doors according to the present invention.

FIG. 3 illustrates additional embodiments of non-opaque window framing systems for windows and doors according to the present invention.

FIG. 4 illustrates a perspective view of an exemplary increased light transmissive glass block window system in accordance with an embodiment of the present invention.

FIG. 5 illustrates a perspective view of an exemplary increased light transmissive glass block window system having a hopper vent with a detachable screen in accordance with an embodiment of the present invention.

FIG. 6 illustrates an close-up view of the exemplary increased light transmissive glass block window system of FIG. 4.

FIG. 7 illustrates a close-up view of the detail area of FIG. 4.

### DETAILED DESCRIPTION OF THE PREFERRED EMBODIMENT

In describing a preferred embodiment of the present invention as illustrated in the accompanying drawings, specific terminology, such as top, bottom, left, right, interior and exterior, for example, will be utilized for the sake of clarity. However, the invention is not intended to be limited to the specific terms so selected, and it is to be understood that each specific term includes a multitude of equivalents.

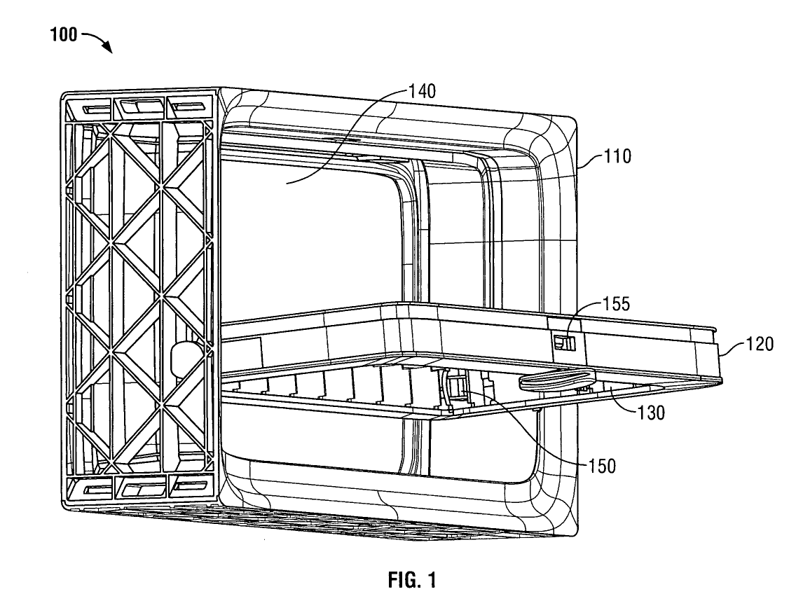

The preferred embodiments of the present invention relate to a window framing system, such as a hopper vent, for example. FIG. 1 illustrates an interior perspective view of a non-opaque hopper vent 100 according to a preferred embodiment of the present invention. The non-opaque hopper vent may be completely composed of either transparent or translucent materials. The hopper vent 100 includes an exterior frame 110, an interior frame 120, a transparent insert 130, and a screen 140. The hopper vent 100 also includes a window lock 155 and a window spring 150. In the preferred embodiment of FIG. 1, the window lock 115 secures the interior frame 120 to the exterior frame 110 and the window spring 150 aids in the positioning of the interior frame 120 within the exterior frame 110. The exterior frame 110 and interior frame 120 are preferably comprised of four injection molded pieces which may be snapped together to form the exterior frame 110 and the interior frame 120.

As shown in FIG. 1, the exterior frame 11 of the hopper vent 100 may be attached to a surrounding glass block window, for example. The exterior frame 110 encloses and is attached to the interior frame 120. The interior frame encloses and supports the transparent insert 130. The screen 140 is removably fixed to the top and bottom of the exterior frame 110.

In a conventional hopper vent, light passes only through a transparent window mounted in an opaque frame. In the hopper vent 100 of FIG. 1, light passes through the transparent insert 130, but also passes through the exterior frame 110 and interior frame 120 directly because the frames 110-120 are also transparent. That is, in a preferred embodiment, the hopper vent 100 is light permeable, and light is able to substantially pass through the exterior frame 110 and interior frame 120, as well as the insert 130.

The structure of the hopper vent 100 is further described in great detail in a pending patent application entitled “Improved Hopper Vent” which was filed on Aug. 17, 2000, and is incorporated herein by reference in its entirety.

In practice, the hopper vent 100 may be included as part of a glass block window typically located as part of an exterior wall of a structure and separating the interior of the structure from the exterior of the structure. The glass block window, and thus also the present invention, may then be understood to include an interior side, viewable from inside the structure, and an exterior side viewable from outside the structure.

In general, the light permeable hopper vent 100 is composed of a transparent, translucent, or tinted material, such as a polycarbonate, for example, LEXAN, NYLON, or acrylic polycarbonate, although other materials may be employed, and is preferably injection molded or extruded. That is, the exterior frame 110, interior frame 120, and screen 140 are composed of the transparent, translucent, or tinted material, but may include additional elements such as the window lock 155, the transparent hinge 160, or the window spring 150, for example, which may be composed of the transparent, translucent, or tinted material, or may alternatively be a non-opaque material such as a metal, for example. Although the additional window elements such as the window spring 150 or window lock 155 for example, are preferably transparent, the additional window elements may be composed of opaque materials such as metal without departing from the spirit of the present invention. The transparent insert 130 is preferably composed of a transparent material, such as glass or other glazing material, for example.

In a typical injection molding process, plastic material, such as powders or pellets of plastic, for example, is mixed and heated until the plastic material liquefies. Next, the liquefied plastic material is introduced into a shaped mold. Then, the mold is allowed to cool. As the mold cools, the liquefied plastic material solidifies and conforms to the shape of the mold.

In a typical extrusion process, plastic material, such as powders or pellets of plastic, for example, is mixed and heated until the plastic material partially liquefies. The partially liquefied plastic material then passes through a die, and lengths of the material are extruded and then cut. The cut lengths of material may then be further manufactured into a desired article.

Because the hopper vent 100 is substantially manufactured from a transparent, translucent, or tinted material, such as LEXAN polycarbonate, NYLON, or Acrylic, for example, the hopper vent 100 is transparent when completed through injection molding, extrusion, or other such process. Alternatively, the hopper vent 100 may be tinted to any of a variety of colors through the addition of a commercially available color additive, such as polycarbonate coloring additive to the LEXAN polycarbonate, for example, prior to injection molding. For example, a powdered color additive may be added to the plastic powder and then mixed and heated. Additionally, the transparency of the hopper vent 100 may be altered through the addition of other commercially available additives, such as polycarbonate additives to the LEXAN polycarbonate, for example, prior to injection molding. Alternatively, color additives or other additives may be added to extruded plastic material as well.

The preferred embodiments of the present invention may be either extruded or injection molded. As shown in FIG. 1 and described above, the hopper vent 100 may be simply and easily snapped together without the use of many fastenings. Because the hopper vent 100 minimizes the use of fastenings, the hopper vent 100 preferably includes relatively few interior elements that may interfere with the passage of light through the exterior frame 110 or interior frame 120 of the hopper vent 100 or with the aesthetic appeal of the hopper vent 100.

In an alternative embodiment, the hopper vent 100 or other window may be mounted in an exterior wall. When mounted in an exterior wall, an opaque strip of material may be positioned around the perimeter of the exterior frame 110 of the hopper vent 100 to increase aesthetic appeal by preventing an observer from seeing through the exterior frame 110 and into the interior of the wall.

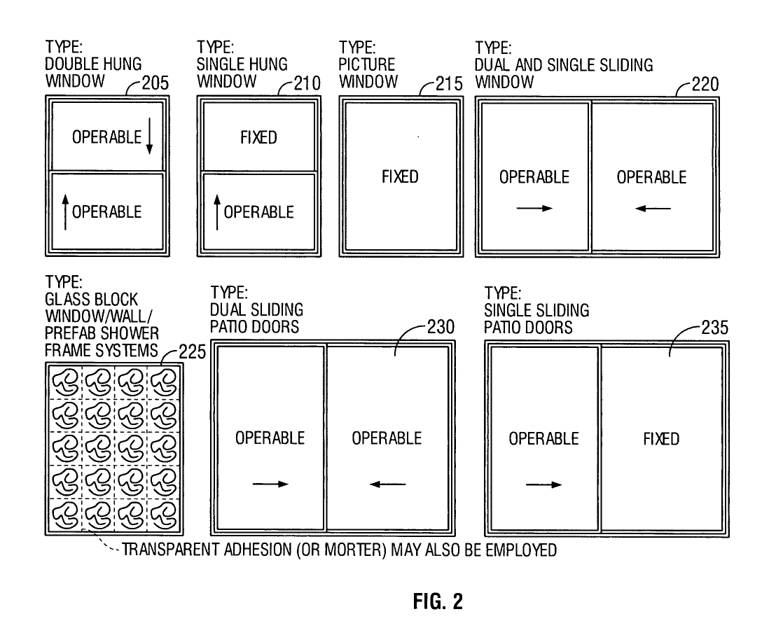

FIG. 2 illustrates several embodiments of non-opaque window framing systems for windows and doors according to the present invention. Examples shown in FIG. 2 include a double hung window 205, a single hung window 210, a picture window 215, a dual or single sliding window 220, a glass block window/wall/prefab shown frame system 225, a dual sliding patio door 230, and a single sliding patio door 235. The examples shown in FIG. 2 represent only a small number of the alternative embodiments of the present invention that may be developed by one skilled in the art.

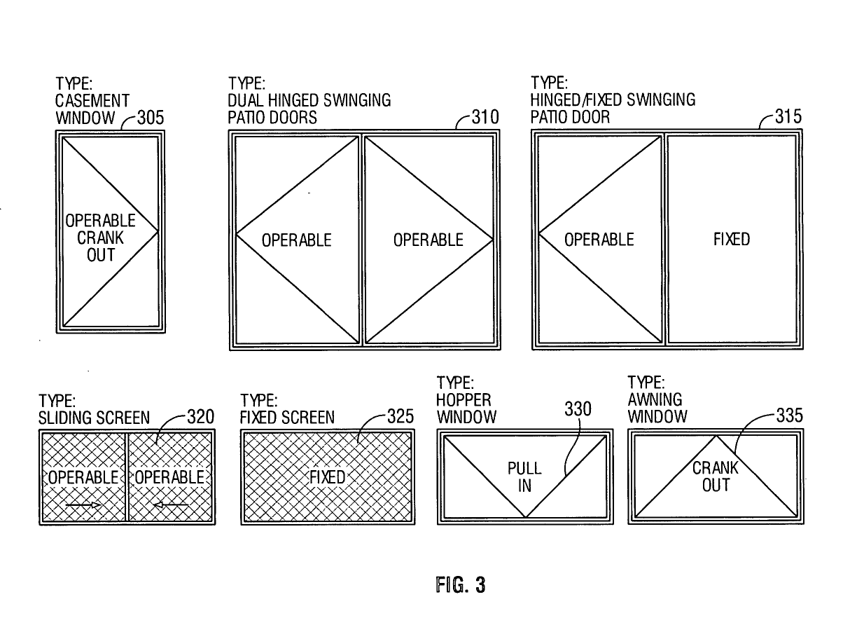

FIG. 3 illustrates additional embodiments of non-opaque window framing systems for windows and doors according to the present invention. Examples shown in FIG. 3 include a casement window 305, a dual hinged swinging patio door 310, a hinged/fixed swinging patio 315, a sliding screen 320, a fixed screen 325, a hopper window 330, and an awning window 335. The examples shown in FIG. 3 represent only a small number of the alternative embodiments of the present invention that may be developed by one skilled in the art.

LEXAN polycarbonate or other light permeable materials may have been previously employed in other fields, for example, commercially available photograph frames for framing photographs for display. However, the use of a transparent, tinted, or translucent material to form a window frame is new. Thus, the present invention includes the concept of maximizing light penetration through a window system while maintaining structural stability, environmental sealing, and aesthetic value.

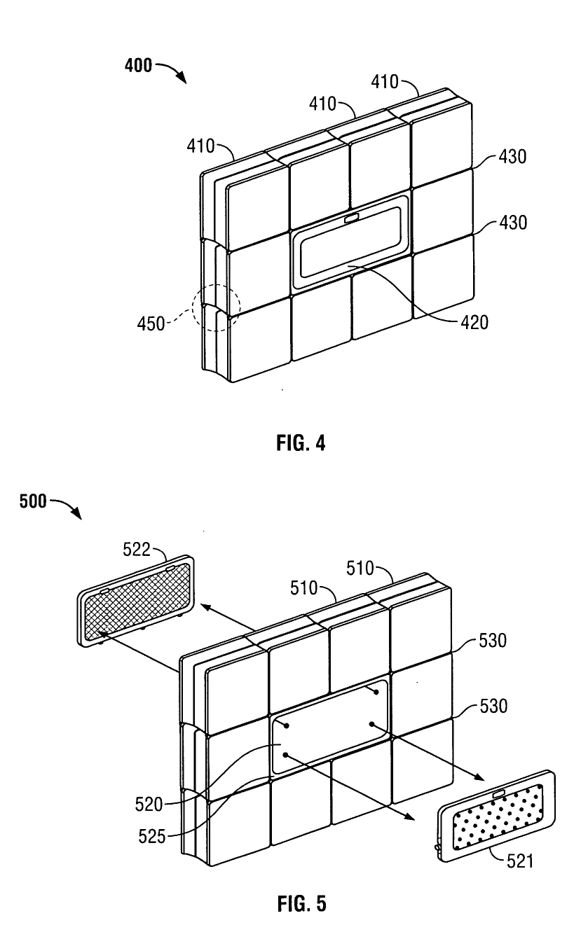

FIG. 4 illustrates a perspective view of an exemplary increased light transmissive glass block window system 400 in accordance with an embodiment of the present invention. The window system 400 includes several glass blocks 410 and a hopper vent 420. The glass block 410 and the hopper vent 420 are sealed together using a substantially transparent adhesive 430. FIG. 4 also illustrates a detail area 450 which is illustrated in enlarged detail in FIG. 7.

As mentioned above, increased light transmission through a window is highly desirable. However, in a conventional glass block window system, although light is fairly well transmitted through the glass blocks, light is usually blocked by an opaque hopper vent and by opaque mortar between the glass blocks and between the glass blocks and the window.

As shown in FIGS. 1 above, a transparent or translucent hoper vent may be used to increase light transmission through the glass block window system. Additionally, the mortar between the glass blocks and the mortar between the glass blocks and the hopper vent may be replaced by a clear adhesive and/or sealant. The resultant glass block window system 400, as illustrated in FIG. 4, includes a substantially transparent hopper vent and substantially transparent glass blocks, all joined together by a substantially transparent adhesive.

Consequently, the glass block window system 400 provides maximal light transmission because all components in the system and the sealant are substantially transparent. That is, the substantially transparent adhesive 430 seals together the elements of the window system 400, such as the glass blocks 410 and the hopper vent 420, but still permits the passage of light in between joined elements of the window system 400. Although light may be allowed to pass between the elements of the window system 400, the substantially transparent adhesive 430 prevents the passage of other natural elements, such as air and water, from passing between the glass blocks 410 and the hopper vent 420.

The exemplary window system 400 of FIG. 4, is preferably constructed in three stages. First, the hopper vent 420 is laterally sealed to two glass blocks 410, one glass block on each side, to form a middle section. As mentioned above, the hopper vent 420 is sealed to the glass blocks 410 using a transparent adhesive 430. Second, a top section and a bottom section of glass blocks 410 are formed. Each of the top and bottom sections are formed by laterally sealing four glass blocks 410 together using a transparent adhesive 430. Finally, the top section and the bottom section are sealed to the middle section to form the window system 400.

In general, the substantially transparent adhesive 430 may be composed of a transparent or translucent material, such as clear acrylic or silicon. However, the window system 400 is preferably formed using a quick-setting silicone transparent adhesive available from Dow Chemical Company. The assignee of the present invention has contracted with Dow to obtain the exclusive right to the use of such a quick-setting silicone transparent adhesive in window applications in the U.S. Alternatively, other transparent adhesives, such as silicon and acrylic adhesives may be employed.

Preferably, the hopper vent 420 and the glass blocks 410 are prefabricated into a number of configurations suitable for incorporation into residential, commercial, and/or industrial designs. Consequently, the consumer may preferably purchase the window system 400 as a prefabricated unit and install the unit in a wall aperture to form a ready-made window.

The embodiment of the window system 400 shown in FIG. 4 is the preferred embodiment, but many alternative embodiments may be envisioned without departing from the teachings of the present invention. For example, although the embodiment of FIG. 4 shows 10 glass blocks, a greater or lesser number of glass blocks may be employed depending upon the dimensions of the window, the dimensions of the hopper vent, and/or the dimensions of the glass blocks themselves. Additionally, although the embodiment of FIG. 4 shows a single, centrally located hopper vent, one or more hopper vents may be employed in various configurations with the glass blocks.

Additionally, although preferably all sealing is performed using a transparent sealant between the glass blocks and/or the hopper vent, any use of transparent sealant would provide some increased light transmission. Consequently, while preferably a transparent sealant is the only sealant applied, any use of transparent sealant provides increased light transmission.

Also, the window system 400 may be installed into a wall as a single unit by fastening the window system into the wall. For example, the window system 400 may be sealed into the wall using the transparent adhesive. Alternatively, the window system 400 may be installed using traditional opaque mortar if a more uniform, opaque white edge is desired by a consumer.

Alternatively, the hopper vent 420 and the sealant 430 may be tinted or translucent. In this regard, some increased light transmission may be provided, while providing a product of a color preferred by the consumer.

FIG. 5 illustrates a perspective view of an exemplary increased light transmissive glass block window system 500 having a hopper vent with a detachable screen in accordance with an embodiment of the present invention. The window system 500 includes several glass blocks 510, a substantially transparent hopper vent 520, and a substantially transparent adhesive 530. The hopper vent 520 includes a sash window 521, a detachable screen 522, and an exterior frame 525. The preferred structure of the hopper vent 520 is more extensively disclosed in U.S. Pat. No. 6,435,251 entitled “Hopper Vent” which is hereby incorporated by reference in its entirety.

The window system 500 of FIG. 5 is similar to the window system 400 of FIG. 4, but the window system 500 of FIG. 5 includes a hopper vent 520 having a sash window 521 and a detachable screen 522. As discussed above, all elements of the hopper vent 420, including the sash window 521, detachable screen 522, and exterior frame 525 are preferably composed of transparent and/or translucent materials as set forth with regard to FIG. 1.

As discussed above with regard to FIG. 4, the glass blocks 510 and the transparent hopper vent 520 are preferably bonded together using a transparent adhesive.

The detachable screen 522 and sash window 521 provide easy access through the window system 500, for example for cleaning of the detachable screen 522 and the sash window 521. Alternatively, the detachable screen 522 and/or the sash window 521 may be removed by a consumer for aesthetic reasons, for example, or to increase light transmission.

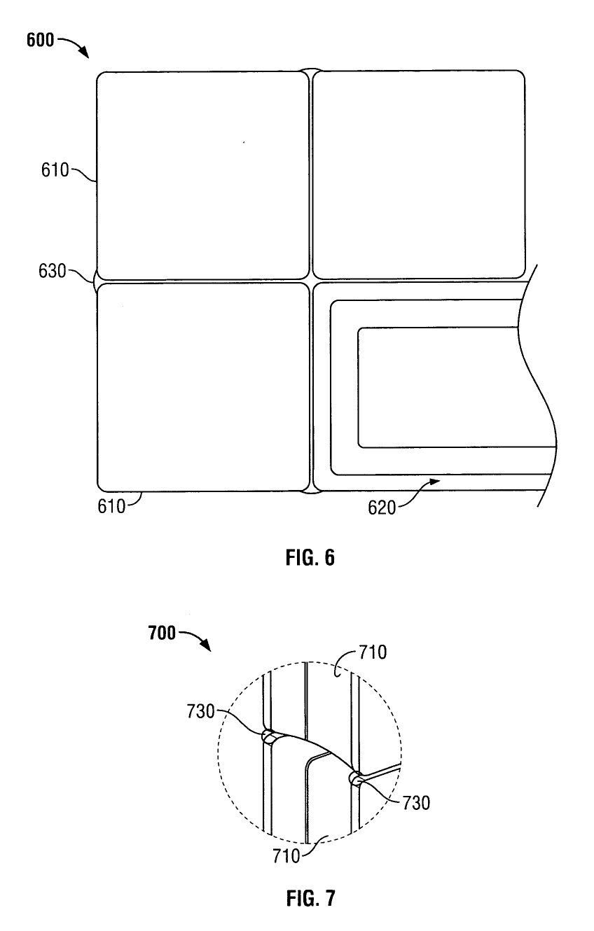

FIG. 6 illustrates an close-up view 600 of the exemplary increased light transmissive glass block window system 400 of FIG. 4. The close-up view 600 includes several glass blocks 610, a substantially transparent hopper vent 620, and a substantially transparent adhesive 630. As illustrated in FIG. 6, the substantially transparent adhesive 630 is preferably positioned between the glass blocks 410 to bond the glass blocks 410 together and the transparent adhesive 630 is also preferably positioned between the glass blocks 410 and the substantially transparent hopper vent 420 to bond the glass blocks 410 to the hopper vent 420.

FIG. 7 illustrates a close-up view 700 of area 450 of FIG. 4. The close-up view 700 includes two glass blocks 710 and two strips of substantially transparent adhesive 730. As shown in FIG. 7, the glass blocks 710 are sealed together using the transparent adhesive 730.

The transparent adhesive 703 is preferably applied as two strips. The first strip is preferably positioned in a plane with the interior faces of the glass blocks and between the interior faces of the glass blocks 410 as shown in FIG. 7. The second strip is preferably positioned in a plane with the exterior faces of the glass blocks and between the exterior faces of the glass blocks 410 as shown in FIG. 7.

Although the transparent adhesive 730 is preferably positioned as shown in FIG. 7, several orientations for the transparent adhesive 730 are possible. For example, the transparent adhesive 730 may be applied as a single strip extending from the exterior face of the glass blocks 710 to the interior face of the glass blocks 710. Any amount of transparent adhesive 730 may be employed that is sufficient to seal the glass blocks 710 and/or hopper vent 720 together

While the invention has been described with reference to an embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A prefabricated glass block window system, said system including:
a substantially transparent glass block; and
a substantially transparent window,
wherein said substantially transparent glass block is bonded to said substantially transparent window using a substantially transparent adhesive.

2. The window system of claim 1 further including an additional transparent glass block, wherein said additional glass block is also bonded to said substantially transparent window using said substantially transparent adhesive.

3. The window system of claim 1 further including an additional transparent glass block, wherein said additional glass block is also bonded to said substantially transparent glass block using said substantially transparent adhesive.

4. A glass block window system, said window system including:
a first light permeable glass block;
a second light permeable glass block;
a light permeable window, wherein said window includes a frame composed of light-permeable materials; and
a light permeable adhesive,
wherein said adhesive is interposed between at least one of said window and said first or second light permeable glass block and between said first light permeable glass block and said second light permeable glass block.

5. The window system of claim 4 wherein said light permeable window includes a sash window having a sash that may be placed in an open position.

6. The window system of claim 5 wherein said sash window is substantially transparent.

7. The window system of claim 4 wherein said light permeable window includes a detachable screen.

8. The window system of claim 7 wherein said detachable screen is composed of substantially transparent materials.

9. A method of fabricating a glass block window system, said method including:
bonding a substantially transparent glass block to a substantially transparent window using a substantially transparent adhesive.

10. The method of claim 9 wherein said bonding step provides a single, prefabricated unit.

11. The method of claim 9 further including:
bonding an additional substantially transparent glass block to at least one of said substantially transparent glass block and said substantially transparent window.
